(19) United States
(12) Patent Application Publication
(10) Pub. No.: US 2024/0384183 A1
(43) Pub. Date: Nov. 21, 2024

(54) USE OF TRANSITION METAL DOPED NANOPARTICLES AND SILICA NANOPARTICLES FOR H2S REMOVAL

(71) Applicant: NISSAN CHEMICAL AMERICA CORPORATION, Houston, TX (US)

(72) Inventors: Clive COADY, Geneva, IL (US); Samuel James MAGUIRE-BOYLE, Spring, TX (US); John Edmond SOUTHWELL, Glen Ellyn, IL (US)

(21) Appl. No.: 18/546,662

(22) PCT Filed: Feb. 18, 2022
(86) PCT No.: PCT/US2022/016952

§ 371 Date: Aug. 16, 2023

Related U.S. Application Data
(60) Provisional application No. 63/151,245, filed on Feb. 19, 2021.

(51) Int. Cl. C10G 29/16; B01D 53/02; C01B 32/50; C02F 1/68; C02F 101/10; C02F 103/34; C10L 3/10

(52) U.S. Cl. CPC C10G 29/16; B01D 53/02; C01B 32/50; C02F 1/683; C10L 3/103; B01D 2253/1122; B01D 2253/25; B01D 2257/304; C02F 2101/101; C02F 2103/34; C10G 2300/207

(57) ABSTRACT

A process to remove H₂S from a stream comprising the steps of adding a dispersion of colloidal nanoparticles having surface functionality comprising Copper, Zinc, Iron, or Manganese, and a triazine. The stream is selected from the group consisting of Oil streams, Gas streams, CO₂ point source purification streams, and Geothermal Energy System streams.

### CROSS-REFERENCE TO RELATED APPLICATIONS

This application is the US national phase of PCT/US2022/016952, filed Feb. 18, 2022, which claims the benefit of U.S. Application No. 63/151,245, filed Feb. 19, 2021, the entire contents of each of which are incorporated herein by reference.

### FIELD OF THE INVENTION

This invention is in the field of chemicals used to remove hydrogen sulfide (H₂S) from Oil streams, Gas streams, CO₂ point source purification and Geothermal Energy Systems.

### BACKGROUND OF THE INVENTION

Hydrogen sulfide is present in natural gas from many gas fields. It can also be present in Oil streams, Gas streams, CO₂ point source purification and Geothermal Energy Systems.

It is a highly undesirable constituent because it is toxic and corrosive and has a very foul odor. Therefore, several methods for its removal have been developed. These include adding triazines or glyoxals to the oil or gas streams. H₂S removal strategies employing solid-supported oxides of transition metals such Copper, Zinc, Iron, Manganese, or Nickel are known and variously employed in the oil & gas industry, specifically in purification of natural gas. These strategies are known to have varying levels of success due to low efficiency and low removal capacities at ambient temperatures. Preparation of CuO nanoparticles for H₂S treatment is known, preparation of nanoscale CuO being demonstrated by methods of sol-gel, precipitation, hydrothermal treatment, hydrolysis, and electrospinning. These approaches have demonstrated preparation of dry nanomaterials capable of scavenging H₂S with good activity but are designed specifically to isolate dry particles, limiting the application method. Furthermore, preparation or pure CuO materials in practice would be economically undesirable due to the inherently high cost of metal oxide materials in comparison with the necessity to remove large amounts of H₂S from a typical field application. The use of inexpensive colloidal silica as a template for metal oxide nanomaterials, in comparison, is a relatively inexpensive and efficient way to provide transition metal oxide in extremely high surface areas, as well as provide a convenient liquid form of method application desirable in the H₂S scavenging market.

US 2005/084438, “Method for Reducing Odor Using Metal-Modified Silica Particles”, issued as U.S. Pat. No. 7,438,875 B2 on Oct. 21, 2008. This patent describes and claims a method for reducing odor is provided. In one embodiment, the method comprises modifying the surface of silica particles with a transition metal so that the silica particles are bonded to the transition metal through a covalent or coordinate bond. The method further comprises contacting the modified silica particles with an odorous compound, the transition metal facilitating the capture of the odorous compound.

“Copper Coated Silica Nanoparticles for Odor Removal”, Langmuir, American Chemical Society, US, vol. 26, no 2014 September 2010 (2010 Sep. 14) pages 15837-15844, XP002739110, describes work done on Copper species coated silica nanoparticle (CuOXS) were synthesized for odor removal application. Coating with copper increased the capacity of silica nanoparticles for eliminating a model odor-ethyl mercaptan. Surface area, pore size distribution, and electron paramagnetic resonance spectroscopy analyses indicated that, at lower copper concentrations, copper species preferentially adsorb in 20 Å pores of silica. These copper species in a dispersed state are effective in catalytic removal of ethyl mercaptans. The best performance of copper-coated silica nanoparticles was achieved at a copper concentration of 3 wt. %, at which all 20 Å nanopores were filled with isolated copper species. At higher copper loading, copper species are present as clusters on silica surfaces, which were found to be less effective in removing ethyl mercaptan.

Odour Management Guidance for Refineries, Hoven L., 1 Jan. 2020, pages 1-93, XP055851362, describes some of the main aspects relating to odour emissions at refineries that should be considered. These include methods of measuring and investigation odour, the key regulatory instruments, odour management and control methods, contents of an odour management plan (OMP) and implementation of an odour complaint handling system.

US 2005/085144 A1, “Durable charged particle coatings and materials” issued as U.S. Pat. No. 7,141,518 B2 on Nov. 28, 2006. This patent describes and claims coatings having high surface area materials and at least one metal ion adsorbed onto the high surface area material as well as substrates having the coating and methods of applying the coating. The substrates may be films, woven fabrics or may be nonwoven fabrics. The coatings have good odor and/or gas absorbing capabilities. Nonwoven fabrics include tissues, towels, coform materials, bonded carded webs, spunbond fabrics and so forth. The substrates may be made into storage and packaging material to reduce odor and retard the ripening of fruit. The substrates may be used in personal care products, to produce clothing for military and civilian applications and many other applications.

US 2013/204065 A1, “Protected Adsorbents for Mercury Removal and Method of Making and Using Same” issued as U.S. Pat. No. 9,006,508 B2 on Apr. 14, 2015. This patent describes and claims a method of removing mercury and/or sulfur from a fluid stream comprising contacting the fluid stream with a sorbent comprising a core and a porous shell formed to include a plurality of pores extending therethrough and communicating with the core. The core comprises a copper compound selected from the group consisting of a basic copper oxysalt, a copper oxide, and a copper sulfide.

US 2018/291284 A1 “Microparticles For Capturing Mercaptans” published on Oct. 11, 2018, and is assigned to Ecolab. This now abandoned patent application describes and claims scavenging and antifouling nanoparticle compositions useful in applications relating to the production, transportation, storage, and separation of crude oil and natural gas, as well as oral hygiene. Also disclosed are methods of making the nanoparticle compositions as scavengers and antifoulants, particularly in applications relating to the production, transportation, storage, and separation of crude oil and natural gas, as well as oral hygiene.

U.S. Pat. No. 5,980,845 “Regeneration of Hydrogen Sulfide Scavengers”, issued on Nov. 9, 1999. This issued US patent describes and claims sulfide scavenger solutions and processes that have high sulfide scavenging capacity, provide a reduction or elimination of solids formation and avoid the use of chemicals that pose environmental concerns. The invention utilizes a dialdehyde, preferably ethanedial, for the purpose of reacting with amines, amine carbonates, or other derivatives of amines that are liberated when certain scavenger solutions react with sulfides, including hydrogen sulfide and mercaptans. The scavenger solutions that have been discovered to liberate amines are those formed by a reaction between an amine and an aldehyde.

### SUMMARY OF THE INVENTION

The first aspect of the instant claimed invention is a process to remove H₂S from a stream comprising the steps of
(A) adding a fluid comprising
   (i) a dispersion of colloidal nanoparticles having surface functionality comprising Copper, Zinc, Iron, or Manganese, and
   (ii) a triazine
wherein the stream is selected from the group consisting of Oil streams, Gas streams, CO₂ point source purification streams and Geothermal Energy System streams.

The second aspect of the instant claimed invention is a process to remove H₂S from a stream comprising the step of
(A) adding a fluid comprising a
   (i) colloidal dispersion of CuOXS nanoparticles; and,
   (ii) a triazine,
   wherein the stream is selected from the group consisting of Oil streams, Gas streams, CO₂ point source purification streams and Geothermal Energy System streams.

### DETAILED DESCRIPTION OF THE INVENTION

Convenient and economical methods include the use of colloidal silicon dioxide particles as a template for transition metal oxide or halide surfaces. Copper, Iron, and Manganese metallic centers are known to efficiently react with H₂S forming insoluble Sulfides. Copper, Zinc, Iron, or Manganese centers bound to silica nanoparticles, having reacted with H₂S to form the corresponding Sulfide, can then be conveniently removed from the oil or gas stream.

A dispersion of CuOXS, which is a dispersion of colloidal silica surface treated with a combination of CuO and CuCl₂ is commercially available from Nissan Chemical America Corporation of Houston, Texas.

For purposes of this patent application, silica nanoparticles include silica nanoparticles, alumina nanoparticles and silica-alumina nanoparticles.

The silica nanoparticles are sourced from all forms of precipitated SiO₂
a) dry silica;
b) fumed silica;
c) colloidal silica;
d) surface treated silicas including silicas reacted with organosilanes;
e) metal or metal-oxide with silica combinations; and
f) precipitated silica.

There are known ways to modify the surface of colloidal silica:
1. Covalent attachment of Inorganic oxides other than silica.
2. Non-covalent attachment of small molecule, oligomeric, or polymeric organic materials (PEG treatment, amines or polyamines, sulfides, etc.).
3. Covalent attachment of organic molecule including oligomeric and polymeric species:
   a. Reaction with organosilanes/titanates/zirconates/germinates.
   b. Formation of organosilanes/titanate/zirconate/germinate oligomers followed by reaction of these with surface of colloidal silica.
   c. Silanization followed by post-reaction formation of oligomeric/dendritic/hyperbranched/polymeric species starting from colloidal silica surface.
   d. Formation of oligomeric/dendritic/hyperbranched/polymeric silanes/zirconates/titanates followed by reaction to SiO₂ surface.

The silica particles included in the colloidal silica may have any suitable average diameter. As used herein, the average diameter of silica particles refers to the average largest cross-sectional dimension of the silica particle. In an embodiment, the silica particles may have an average diameter of between about 0.1 nm and about 100 nm. In an embodiment, the silica particles may have an average diameter of between about 1 nm and about 100 nm. In an embodiment, the silica particles may have an average diameter of between about 5 nm and about 100 nm. In an embodiment, the silica particles may have an average diameter of between about 1 nm and about 50 nm. In an embodiment, the silica particles may have an average diameter of between about 5 nm and about 50 nm. In an embodiment, the silica particles may have an average diameter of between about 1 nm and about 40 nm. In an embodiment, the silica particles may have an average diameter of between about 5 nm and about 40 nm. In an embodiment, the silica particles may have an average diameter of between about 1 nm and about 30 nm. In an embodiment, the silica particles may have an average diameter of between about 5 nm and about 30 nm. In an embodiment, the silica particles may have an average diameter of between about 7 nm and about 20 nm.

In an embodiment, the silica particles have an average diameter of less than or equal to about 30 nm. In another embodiment, the silica particles may have an average diameter of less than or equal to about 25 nm. In another embodiment, the silica particles may have an average diameter of less than or equal to about 20 nm. In another embodiment, the silica particles may have an average diameter of less than or equal to about 15 nm. In another embodiment, the silica particles may have an average diameter of less than or equal to about 10 nm. In another embodiment, the silica particles may have an average diameter of less than or equal to about 7 nm. In another embodiment, the silica particles may have an average diameter of at least about 5 nm. In another embodiment, the silica particles may have an average diameter of at least about 7 nm. In another embodiment, the silica particles may have an average diameter of at least about 10 nm. In another embodiment, the silica particles may have an average diameter of at least about 15 nm. In another embodiment, the silica particles may have an average diameter of at least about 20 nm. In another embodiment, the silica particles may have an average diameter of at least about 25 nm. Combinations of the above-referenced ranges are also possible.

Colloidal silica is a flexible technology medium, allowing for customized surface treatment based on application. In an embodiment, the silica is a GlycidoxyPropylTriMethoxySilane-functional silica. GPTMS-functionalized silica includes alkaline sol silica, available from Nissan Chemical America as ST-V3. Another GPTMS-functionalized silica is an acidic type of silica sol, available from Nissan Chemical America as ST-OV3.

The amount of silica nanoparticle used per unit of H₂S is as follows:

In an embodiment, 1 unit of silica nanoparticle per 3 units of H₂S, in another embodiment, 1 unit of silica nanoparticle per 5 units of H₂S and in another embodiment, 1 unit of silica nanoparticle per 10 units of H₂S.

The alumina nanoparticles are sourced from all forms of precipitated Al₂O₃
a) dry alumina;
b) fumed alumina;
c) colloidal alumina;
d) surface treated aluminas including aluminas reacted with organosilanes;
e) metal or metal-oxide with alumina combinations; and
f) precipitated alumina.

There are known ways to modify the surface of colloidal alumina:
1. Covalent attachment of Inorganic oxides other than alumina.
2. Non-covalent attachment of small molecule, oligomeric, or polymeric organic materials (PEG treatment, amines or polyamines, sulfides, etc.).
3. Covalent attachment of organic molecule including oligomeric and polymeric species:
   a. Reaction with organosilanes/titanates/zirconates/germinates.
   b. Formation of organosilanes/titanate/zirconate/germinate oligomers followed by reaction of these with surface of colloidal alumina.
   c. Silanization followed by post-reaction formation of oligomeric/dendritic/hyperbranched/polymeric species starting from colloidal alumina surface.
   d. Formation of oligomeric/dendritic/hyperbranched/polymeric silanes/zirconates/titanates followed by reaction to Al₂O₃ surface.

The alumina particles included in the colloidal alumina may have any suitable average diameter. As used herein, the average diameter of alumina particles refers to the average largest cross-sectional dimension of the alumina particle. In an embodiment, the alumina particles may have an average diameter of between about 0.1 nm and about 100 nm. In another embodiment, the alumina particles may have an average diameter of between about 1 nm and about 100 nm. In another embodiment, the alumina particles may have an average diameter of between about 5 nm and about 100 nm. In another embodiment, the alumina particles may have an average diameter of between about 1 nm and about 50 nm. In another embodiment, the alumina particles may have an average diameter of between about 5 nm and about 50 nm. In another embodiment, the alumina particles may have an average diameter of between about 1 nm and about 40 nm. In another embodiment, the alumina particles may have an average diameter of between about 5 nm and about 40 nm. In another embodiment, the alumina particles may have an average diameter of between about 1 nm and about 30 nm. In another embodiment, the alumina particles may have an average diameter of between about 5 nm and about 30 nm. In another embodiment, the alumina particles may have an average diameter of between about 7 nm and about 20 nm.

In an embodiment, the alumina particles have an average diameter of less than or equal to about 30 nm. In an embodiment, the alumina particles have an average diameter of less than or equal to about 25 nm. In an embodiment, the alumina particles have an average diameter of less than or equal to about 20 nm. In an embodiment, the alumina particles have an average diameter of less than or equal to about 15 nm. In an embodiment, the alumina particles have an average diameter of less than or equal to about 10 nm. In an embodiment, the alumina particles have an average diameter of less than or equal to about 7 nm. In an embodiment, the alumina particles have an average diameter of at least about 5 nm. In an embodiment, the alumina particles have an average diameter of at least about 7 nm. In an embodiment, the alumina particles have an average diameter of at least about 10 nm. In an embodiment, the alumina particles have an average diameter of at least about 15 nm. In an embodiment, the alumina particles have an average diameter of at least about 20 nm. In an embodiment, the alumina particles have an average diameter of at least about 25 nm. Combinations of the above-referenced ranges are also possible.

Colloidal alumina is a flexible technology medium, allowing for customized surface treatment based on application. In an embodiment, the alumina is a GPTMS-functional alumina. GlycidoxyPropylTriMethoxySilane-functional alumina includes alkaline sol silica, available from Nissan Chemical America as AT-V6. Another GPTMS-functionalized alumina is an acidic type of silica sol, available from Nissan Chemical America as AT-OV6.

The amount of alumina nanoparticle used per unit of H2S is as follows: 1 unit of alumina nanoparticle per 3 units of H2S, in another embodiment, 1 unit of alumina nanoparticle per 5 units of H2S and in another embodiment, 1 unit of alumina nanoparticle per 10 units of H2S.

Some examples of nanoparticles can include particles of spherical shape, fused particles such as fused silica or alumina or particles grown in an autoclave to form a raspberry style morphology, or elongated silica particles. The particles being bare, or surface treated. When surface treated may be polar or non-polar.

The surface treatment is sufficient to allow the nanoparticle to be stable during transportation to the area where a H₂S sorbent is required and for delivery. The stability achieved either by covalent, charge-charge, dipole-dipole, or charge-dipole interactions.

Triazines useful in the instant claimed invention include, but are not limited to, 1,2,3-triazine; 1,2,4-triazine and 1,3,5-triazine (aka s-triazine). Triazines useful in the instant claimed invention include Hexahydro-1,3,5-tris(hydroxyethyl)-s-triazine.

Triazines are alkaline and can cause carbonate scaling. Triazines are commercially available.

Triazines can be present in the process at a level of from about zero point 1 (0.1) units to about 1 unit per 3 units of H2S. Units could mean any quantitative measure, such as grams, pounds, mols, etc. etc.

CO₂ Point Source Purification is described in “Evaluation of CO₂ Purification Requirements and the Selection of Processes for Impurities Deep Removal from the CO₂ Product Stream”, Zeina Abbas et al, Energy Procedia, Volume 37, 2013, Pages 2389-2396. Depending on the reference power plant, the type of fuel and the capture method used, the CO₂ product stream contains several impurities which may have a negative impact on pipeline transportation, geological storage and/or Enhanced Oil Recovery (EOR) applications. All negative impacts require setting stringent quality standards for each application and purifying the CO₂ stream prior to exposing it to any of these applications.

In the Abbas paper, the CO₂ stream specifications and impurities from the conventional post-combustion capture technology are assessed. Furthermore, the CO₂ restricted purification requirements for pipeline transportation, EOR and geological storage are evaluated. Upon the comparison of the levels of impurities present in the CO₂ stream and their restricted targets, it was found that the two major impurities which entail deep removal, due to operational concerns, are oxygen and water from 300 ppmv to 10 ppmv and 7.3% to 50 ppmv respectively. Moreover, a list of plausible technologies for oxygen and water removal is explored after which the selection of the most promising technologies is made. It was found that catalytic oxidation of hydrogen and refrigeration and condensation are the most promising technologies for oxygen and water removal respectively.

“Geothermal Energy System Streams” are described as follows:
Hot water is pumped from deep underground through a well under high pressure.
When the water reaches the surface, the pressure is dropped, which causes the water to turn into steam.
The steam spins a turbine, which is connected to a generator that produces electricity.
The steam cools off in a cooling tower and condenses back to water.

### EXAMPLES

### Materials

Stepanquat 200 is a 78.5% actives solution of Hexahydro-1,3,5-tris(hydroxyethyl)-s-triazine available commercially from Stepan Corp.

ST-O40, ST-30, ST-OV4, PGM-ST, ST-C, ST-V3, and MT-ST are commercially available colloidal silica products from Nissan Chemical America Corporation.

Organosilanes, Propylene Glycol Monomethyl Ether solvent, NaHCO₃, CuCl₂—H₂O, and Glyoxal were procured from Sigma Aldrich Corp.

Synthesis example 1: 1000 mL Snowtex® ST-30 from Nissan Chemical America Corporation (Aqueous alkaline colloidal silica dispersion, 30 wt % SiO₂ solids, 10-15 median particle size) was placed into a 2000 mL 4 neck glass reactor assembled with addition funnel, thermometer, heating mantle connected to voltage regulator, and mixer with 2 inch diameter trifoil mixing blade. Mixing was activated at 150 rpm and silicasol was brought to 50° C. Into the addition funnel was weighed 49.98 g of Aminoethylaminocthylaminopropyl Trimethoxysilane (CAS #35141-30-1. Sigma-Aldrich). Addition funnel was assembled to reactor top and silane was slowly added to stirring silicasol at a drop rate of 2 drops per second. After all organosilane had been added to reaction the mixture was allowed to stir at 50° C. for a period of 3 hours. Finished surface-treated alkaline silica was poured off to a 2 L Nalgene bottle for storage and use.

### Synthesis Example 2

1.4 L Snowtex® O—XS (Aqueous acidic colloidal silica dispersion, 10 wt % colloidal silica median particle size 5 nm) was transferred to a 4-neck reaction kettle. To this vessel were also added 9.6 L distilled water. Copper (II) Chloride dehydrate (CuCl₂—H₂O, Sigma Aldrich), 13.87 g were added to the reaction flask and allowed to dissolve at room temperature under light agitation. A stock solution (“Solution A”) of NaHCO₃(Sigma Aldrich ACS reagent grade, ≥99.7% was prepared (47.04 g NaHCO₃ dissolved in 12.6 L distilled water, 0.04 M final concentration). The stir rate in the reaction vessel was increased to 9500 rpm to achieve vigorous agitation. Solution A was added slowly 10-15 mL per minute to the reaction via addition funnel. After Solution A was added completely the reaction was allowed to stir at room temperature for 30 minutes and contents were removed for storage and use.

### Synthesis Example 3

Snowtex® PGM-ST (Solvent borne dispersion of acidic colloidal silica, 30 wt % SiO2 median particle size 10-15 nm dispersed in Propylene Glycol Monomethyl ether), 450 g were placed into a 1000 mL 4-neck reaction flask. Similar to Synthesis Example 1 the reactor was assembled with mixer, thermometer, and heating mantle/voltage regulator. A 4.05 g portion of 3-Mercaptopropyl Trimethoxysilane (Sigma Aldrich) were added to an addition funnel and assembled to the reactor. PGM-ST was brought to 50° C. under mild agitation and Mercaptopropyl trimethoxysilane was added dropwise via addition funnel at 1 drop/second until addition was complete. Reaction was kept at 50° C. for a period of 3 hours, then the surface-treated silicasol was poured off to a Nalgene container for storage and use.

### Example 1, Comparative

Into a 1000 mL Nalgene bottle were placed 300 g distilled H₂O, 300 g Propylene Glycol Monomethyl Ether (“PGM”) solvent, and 300 g Stepanquat 200. Contents were mixed thoroughly by shaking container vigorously for 30 seconds.

### Example 2

Into a 1000 mL Nalgene bottle were placed 300 g distilled H₂O, 300 g Propylene Glycol Monomethyl Ether solvent, and 300 g Synthesis Example 1 fluid. Contents were mixed thoroughly by shaking container vigorously for 30 seconds.

### Example 3, Comparative

Into a 1000 mL Nalgene bottle were placed 700 g distilled H₂O, and 300 g Stepanquat 200. Contents were mixed thoroughly by shaking container vigorously for 30 seconds.

### Example 4

Into a 1000 mL Nalgene bottle were placed 300 g distilled H₂O, 300 g ST-O40 (Aqueous acidic colloidal silica available from Nissan Chemical America Corporation), and 300 g Stepanquat 200. Contents were mixed thoroughly by shaking container vigorously for 30 seconds.

### Example 5

Into a 1000 mL Nalgene bottle were placed 300 g distilled H₂O, 300 g Synthesis Example 2 fluid, and 300 g Stepanquat 200. Contents were mixed thoroughly by shaking container vigorously for 30 seconds.

### Example 6

Into a 1000 mL Nalgene bottle were placed 300 g distilled H₂O, 300 g ST-OV4 (Aqueous acidic hydrophilic surface treated colloidal silica available from Nissan Chemical America Corporation), and 300 g Stepanquat 200. Contents were mixed thoroughly by shaking container vigorously for 30 seconds.

### Example 7

Into a 1000 mL Nalgene bottle were placed 300 g distilled H₂O, 300 g Synthesis Example 3 fluid, and 300 g Stepanquat 200. Contents were mixed thoroughly by shaking container vigorously for 30 seconds.

### Example 8

Into a 1000 mL Nalgene bottle were placed 375 g aqueous solution of Glyoxal (Sigma Aldrich, 37.5 wt %) and 625 g ST-C (Aqueous alkaline colloidal silica dispersion partially surface treated with Aluminum Oxide available from Nissan Chemical America Corporation). Contents were mixed thoroughly by shaking container vigorously for 30 seconds.

### Example 9

Into a 1000 mL Nalgene bottle were placed 375 g aqueous solution of Glyoxal (Sigma Aldrich, 37.5 wt %) and 625 g ST-O40 (Aqueous acidic colloidal silica dispersion available from Nissan Chemical America Corporation). Contents were mixed thoroughly by shaking container vigorously for 30 seconds.

### Example 10

Into a 1000 mL Nalgene bottle were placed 375 g aqueous solution of Glyoxal (Sigma Aldrich, 37.5 wt %) and 625 g ST-V3 (Aqueous alkaline hydrophilic surface treated colloidal silica dispersion available from Nissan Chemical America Corporation). Contents were mixed thoroughly by shaking container vigorously for 30 seconds.

### Example 11

Into a 1000 mL Nalgene bottle were placed 375 g aqueous solution of Glyoxal (Sigma Aldrich, 37.5 wt %) and 625 g MT-ST (Solvent borne acidic colloidal silica dispersed in Methanol, 30 wt % SiO2, 10-15 nm median particle size, available from Nissan Chemical America Corporation). Contents were mixed thoroughly by shaking container vigorously for 30 seconds.

### Example 12: Comparative

Into a 1000 mL Nalgene bottle were placed 375 g aqueous solution of Glyoxal (Sigma Aldrich, 37.5 wt %) and 625 g distilled H₂O. Contents were mixed thoroughly by shaking container vigorously for 30 seconds.

MEA Triazine was kept at a constant concentration across all the Inventive and Comparative examples. Similarly, Glyoxal concentration was kept constant across all Inventive and Comparative examples.

### Testing for Removal of H₂S

Each solution tested was equilibrated for weight at 300 g total solution and placed into a vessel with overhead port to measure H₂S content in the vessel headspace. The headspace port was connected to a Dräger Pac® 3500 gas monitor (Drägerwerk AG&Co. KGaA). A mixed gas of 10% H₂S/90% Nitrogen was bubbled through the test solution at a standard rate of 475 mL/minute, solution held at 22° C., and headspace monitored for H₂S content. A reading of 0 means the sensor is not detecting any H₂S in the flow gas stream after the gas has passed through the tested solution. Vessel headspace was monitored for H₂S content once per minute continuously until a H₂S content of 40 reading on gas monitor was reached, at which point the test example in solution reacting with H₂S was considered to be consumed and the experiment stopped. Times to initial H₂S reading and Time to complete H₂S breakthrough were recorded and compared to controls/comparative examples.

### Summary of Results

The Number of minutes is listed is how long the detector detected a value of “0” for H2S. The Table is ordered from best performance in terms of removal of H2S to worst performance.

| | Time to | Time to | | |
|---|---|---|---|---|
| | initial H2S | 40% H2S | | |
| | reading | reading | | |
| Example | (minutes) | (minutes) | Composition | nanoparticle type |
| 2 | 124 | 160 | Triazine + Water + Amine | Amine-Functional |
| | | | func. SiO2 | SiO2 |
| 1 | 117 | 145 | Triazine + Water + PGMsolvent | none |
| | | | (Comparative Example) | |
| 8 | 107 | 184 | Glyoxal + ST-C | Aluminum oxide |
| | | | | functional SiO2 |
| 4 | 71 | 164 | Triazine + Water + ST-O40 | Aqueous acidic |
| | | | | SiO2 |
| 10 | 55 | 146 | Glyoxal + ST-V3 | Glycidoxy |
| | | | | functional SiO2, |
| | | | | alkaline |
| 5 | 55 | 139 | Triazine + Water + CuOXS | Transition Metal |
| | | | | functional SiO2 |
| 7 | 55 | 105 | Triazine + Water + Mercapto | Mercapto |
| | | | functionalized PGM-ST | Functional SiO2 |
| 9 | 51 | 86 | Glyoxal + ST-O40 | Aqueous acidic |
| | | | | SiO2 |
| 3 | 44 | 61 | Triazine + Water (Comparative | none |
| | | | Example) | |
| 6 | 39 | 153 | Triazine + Water + ST-OV4 | Glycidoxy |
| | | | | functional SiO2, |
| | | | | acidic |
| 12 | 8 | 14 | Glyoxal + Water (Comparative | none |
| | | | Example) | |
| 11 | 1 | 2 | Glyoxal + MT-ST | Solventborne |
| | | | | SiO2, acidic |

### Observations about the Examples

1. Example 1: This is a Triazine controls/comparative examples with MEA Triazine dissolved in a mixture of water and PGM solvent. This example performed very well, much better than MEA Triazine alone at the same concentration dissolved in water. It is believed, without intending to be bound there bye, that it is possible PGM is actually very beneficial in Triazine+H2S reaction.
2. Example 2 (Amine-functional SiO2 combined with Triazine) performed very well compared to the comparative example, with improved/delayed time to initial H2S breakthrough and also time to final breakthrough (when the H2S readings reached a 40% level in the headspace above the sample).
3. Example 3 is the Triazine+water control, these times were used comparatively for all the Triazine+nanosilica examples. Example 3 exemplifies the standard field grade fluid of MEA Triazine fluid for treatment of sour gas.
4. Example 4 (ST-O40, Aqueous acidic silica+Triazine) performed the best of all Triazine+nanosilica examples. It is believed, without intending to be bound thereby, that the solid acidity of the acidic silica surface is likely acting as a catalyst to make the Triazine+H2S reaction more complete, leading to greatly improved/delayed time to initial and complete H2S breakthrough.
5. Example 5 (Copper functionalized nanosilica+Triazine) performed relatively well in improved/delayed time to initial and complete H2S breakthrough. This example is the only example of Transition Metal functional silica. (It is noted that the Aluminum present in Example 8 is not considered a true Transition metal, as it is a “Post Transition Metal”.)
6. Example 6 (ST-OV4+Triazine) is aqueous acidic silica functionalized with hydrophilic organic surface treatment and is commercially available from Nissan Chemical America. This example had slightly worse time to H2S initial breakthrough, but had a greatly improved time to complete H2S breakthrough compared to the control (Example 3).
7. Example 7 (Mercapto-functional nanosilica dispersed in PGM+Triazine)—Slightly improved time to initial H2S breakthrough and much improved time to complete H2S breakthrough. It is believed, without intending to be bound thereby, that the Mercapto surface functionality can disrupt polymer formation in the Triazine+H₂S reaction.
8. Example 8 is ST-C (Aqueous alkaline colloidal silica with Aluminum Oxide surface) combined with Glyoxal. Compared to Glyoxal alone this combination of ST-C+Glyoxal showed dramatic improvements in both time to initial and time to complete H2S breakthrough. The Glyoxal+nanosilica examples performed relatively well. It is noted that the Aluminum present in Ex. 8 is not considered a true Transition metal, as it is a “Post Transition Metal”.
9. Example 9 (ST-O40+Glyoxal) performed much better than Glyoxal alone.
10. Example 10 (ST-V3, Aqueous alkaline silica with hydrophilic organic surface treatment+Glyoxal) performed very well compared to Glyoxal alone.
11. Example 11 (Acidic silica dispersed in Methanol) did not perform well, this example had the worst results of all. It is believed, without intending to be bound thereby that MT-ST completely deactivated Glyoxal from reacting with H2SJ
12. Example 12 is the solution of Glyoxal and water only, a comparative example with no added nanotechnology.

1. A process to remove H₂S from a stream comprising the steps of
(A) Adding a fluid comprising
(i) a dispersion of colloidal nanoparticles having surface functionality comprising Copper, Zinc, Iron, or Manganese, and
(ii) a triazine
wherein the stream is selected from the group consisting of Oil streams, Gas streams, CO₂ point source purification streams and Geothermal Energy System streams.

2. A process to remove H₂S from a stream comprising the step of
(A) adding a fluid comprising a
(i) colloidal dispersion of CuOXS nanoparticles; and,
(ii) a triazine,
wherein the stream is selected from the group consisting of Oil streams, Gas streams, CO₂ point source purification streams and Geothermal Energy System streams.
